(19) United States
(12) Patent Application Publication
(10) Pub. No.: US 2019/0138749 A1
(43) Pub. Date: May 9, 2019

(54) TOTAL PERIODIC DE-IDENTIFICATION MANAGEMENT APPARATUS AND METHOD

(71) Applicant: Electronics and Telecommunications Research Institute, Daejeon (KR)

(72) Inventors: Young Min KIM, Daejeon (KR); Yeon Hee LEE, Daejeon (KR); Sun Jin KIM, Daejeon (KR); Hong Kyu PARK, Daejeon (KR); Se Won OH, Daejeon (KR); Nae Soo KIM, Daejeon (KR); Woong Shik YOU, Sejong-si (KR); Cheol Sig PYO, Sejong-si (KR)

(73) Assignee: Electronics and Telecommunications Research Institute, Daejeon (KR)

(21) Appl. No.: 16/179,424

(22) Filed: Nov. 2, 2018

(30) Foreign Application Priority Data
Nov. 3, 2017 (KR) 10-2017-0145948
Jun. 12, 2018 (KR) 10-2018-0067678

(51) Int. Cl. G06F 21/62

(52) U.S. Cl. CPC G06F 21/6254

(57) ABSTRACT

The present invention is directed to providing a total periodic de-identification management apparatus capable of setting de-identification and degrees of adequacy of non-identified data as unit components, providing work flow information so that an operator can select desired unit components, and performing de-identification to correspond to total periodic work flow parsing information including the combination of the unit components selected by the operator.

### CROSS-REFERENCE TO RELATED APPLICATION

This application claims priority to and the benefit of Korean Patent Application No. 10-2017-0145948, filed on Nov. 3, 2017, and Korean Patent Application No. 10-2018-0067678, filed on Jun. 12, 2018, the disclosure of which is incorporated herein by reference in its entirety.

### BACKGROUND

### 1. Field of the Invention

The present invention relates to a de-identification apparatus for non-identifying personal information collected using an Internet-of-Things (IoT) sensor or the like so that the personal information cannot be identified by others, and more particularly, to a total periodic de-identification management apparatus capable of easily performing processes, such as preprocessing, de-identification, re-identification risk analysis, and data availability verification, on collected data by combining the processes in a desired form.

### 2. Discussion of Related Art

With the advancement of Information Technology (IT) convergence technology such as Internet of Things (IoT), a big data analysis, etc., the demand for data usage has sharply increased and thus major developed countries such as the UK, the USA, and Japan are promoting policies to revitalize data industry.

Thus, not only a big data industry market but also a data broker industry market in which personal information is collected and shared with or distributed to third parties has sharply grown.

In order to keep pace with such a domestic or global trend, attempts have been made to increase the value of data utilization through various policies such as Government 3.0, thereby creating new services and revitalizing new industries.

However, the proliferation of big data and data broker markets is unavoidably directly or indirectly related to large and small personal information leakage incidents.

This can be easily confirmed by personal information re-identifying cases in which personal information was re-identified through a combination with other data even though major identifiers were removed, e.g., the Massachusetts case in 1997, the America Online case in 2006, the Netflix case in 2006, etc.

Accordingly, major developed countries such as the EU, the USA, and the UK have newly established or amended major legislation on de-identification methods (EU GDPR, US HIPAA, and Japan Personal Data Protection Act) to revitalize the data industry while minimizing the possibility of infringement of personal information.

In South Korea, the Office for Government Policy Coordination issued the ‘Personal Information De-identification Measures Guidelines’ clearly suggesting measures criteria for de-identification of personal information and a range of utilization of de-identification information, which are necessary to ensure that big data can be safely used within the framework of the current Personal Information Protection Act.

Nowadays, many open sources (UTD Anonymization Toolbox, Cornell Anonymization Toolkit, Open Anonymizer, uArgus, sdcMicro, ARX de-identifier, etc.) are open globally for de-identification processing, and many de-identification commercial products such as Privacy Analytics Eclipse are on the market.

Such a de-identification solution basically consists of two steps: a de-identification step and an re-identification risk analysis step. Such solutions are merely different in terms of how various de-identification measures can be provided and how various re-identification risk analysis models can be provided, i.e., in terms of functional diversity.

De-identification solutions released in South Korea, such as DataEye PIDI introduced by Penta Systems Technology, Identity Shield introduced by Easycerti, and Analytic DID introduced by Fasoo.com, are the same as existing de-identification solutions in that the De-identification Measures Guidelines-based de-identification measures and KLT-based re-identification risk analysis are performed but are different from the existing de-identification solutions in terms of the diversity of provided functions.

Such domestic and global de-identification solutions can protect personal information to a certain extent by appropriately non-identifying personal information and personal sensitive information and evaluating the adequacy of data obtained by non-identifying the information but cannot be considered to be successful in terms of increasing the value of data utilization aiming to data disclosure.

### SUMMARY OF THE INVENTION

To address the above problem, the present invention is directed to providing a total periodic de-identification management apparatus capable of setting de-identification and degrees of adequacy of non-identified data as unit components, providing work flow information so that an operator can select desired unit components, and performing de-identification to correspond to total periodic work flow parsing information including the combination of the unit components selected by the operator.

Aspects of the present invention are not, however, limited thereto and other aspects mentioned herein will be apparent to those of ordinary skill in the art from the following description.

According to an aspect of the present invention, a total periodic de-identification management apparatus includes a data processing combination unit configured to provide work flow information including unit components necessary for de-identification and evaluation thereof, so that an operator may select a de-identification work flow of personal information, and transmit total periodic work flow parsing information including a combination of unit components according to the operator's selection; a data de-identification processor including unit components embodied as single-operation objects and configured to non-identify data by combining the unit components according to the total periodic work flow parsing information; and a de-identification adequacy evaluator configured to evaluate the de-identification of the data in terms of protection of personal information before the non-identified data is disclosed.

In an embodiment of the present invention, the data de-identification processor may include a unit component for filling a missing value and a unit component for removing an outlier.

In an embodiment of the present invention, the data de-identification processor may further include an attribute management module configured to manage attribute information of collected data in units of columns, i.e., whether each of the columns corresponds to an identifier or sensitive information; and a de-identification measures recommendation module configured to recommend a de-identification measures method by taking into account an attribute and a feature of each of the columns.

The data de-identification processor may include a randomization module including unit components configured to change all or some of randomly selected data values to randomly generated data or add the randomly generated data; a generalization module including unit components configured to generalize and categorize a range of data values to prevent a specific individual from being identified; and a data deletion module including unit components configured to delete a specific data value.

In an embodiment of the present invention, the de-identification adequacy evaluator may include a privacy protection module including a k-anonymity component configured to reduce a probability of identifying a specific individual to 1/k or less so as to measure a degree of adequacy by maintaining a number of records to be k or more in an equivalence class, which is a set of records of identifiers and attributes which are non-identified with the same values; an 1-diversity component configured to allow presence of 1 pieces of different sensitive information in the equivalence class; and a t-proximity component configured to ensure that a difference between a feature distribution in the equivalence class and a feature distribution in all data sets is t or less.

The de-identification adequacy evaluator may include an adequacy analysis and evaluation module configured to finally evaluate adequacy on the basis of a degree of adequacy measured and calculated, a re-identification risk degree, and legislation of a country, the evaluation of the adequacy of the non-identified data being performed using the privacy protection module and the risk analysis module. The de-identification adequacy evaluator may include a personal information legislation management module configured to manage legislation related to protection of personal information of each country.

The de-identification adequacy evaluator may include a component configured to quantitatively measure a re-identification risk degree of the non-identified data.

The de-identification adequacy evaluator may use at least one among a sample uniqueness model, a population uniqueness model, a global risk model, and an HIPAA SafeHarbor model to analyze a risk degree.

In an embodiment of the present invention, the apparatus may further include a data availability evaluator including unit components embodied as single-operation objects, and configured to evaluate a degree of availability of the non-identified data passing the evaluation of the degree of adequacy by combining the unit components according to the total periodic work flow parsing information transmitted from the data processing combination unit.

The data availability evaluator may include a statistical analysis module configured to analyze statistical feature of data, the statistical analysis module including a unit component for obtaining basic data statistics, a unit component for a correlation analysis for each column, and a unit component for obtaining statistical information related to an equivalence class derived through de-identification processing; a data loss rate analysis module configured to handle a net loss rate of data itself other than information contained in the data, the data loss rate analysis module including a unit component for analyzing and comparing a loss rate of the non-identified data with respect to original data, a unit component for analyzing a loss rate in units of columns by expanding a loss rate in units of cells to a loss rate in units of columns, and a unit component for expanding and analyzing the loss rate in a whole data unit; and a learning verification module including a unit component of a leaning model such as a decision tree and regression to compare and analyze a result of learning based on the non-identified data versus a result of learning based on the original data, and analyze a loss rate in terms of statistical and academic purposes which are purposes of data disclosure.

The statistical analysis module may further include a single component having various functions related to statistics information management.

The data availability evaluator may include a unit component for comparing and analyzing a data loss rate on the basis of the difference between a distribution of values of the original data and a distribution of values of the non-identified data, and a unit component for comparing and analyzing a loss rate in units of equivalence classes by taking into account that the de-identification is performed in units of equivalence classes.

The learning verification module may include unit components of various learning models, such as regression, classification, a decision tree, and a support vector machine (SVM), to compare and analyze the result of learning based on the non-identified data versus the result of learning based on the original data.

In an embodiment of the present invention, the apparatus may further include a data availability evaluator configured to measure a degree of availability of the non-identified data in various ways.

In an embodiment of the present invention, the data availability evaluator may include a statistical analysis module including a unit component for calculating basic data statistics, equivalence class statistics, and data value frequency statistics, and performing contingency table functions; and a data loss rate analysis module configured to analyze and compare a loss rate of the non-identified data with respect to original data.

The data availability evaluator may include a unit component configured to evaluate a degree of data availability only on the basis of a data loss rate; and a unit component configured to evaluate a degree of data availability using the statistical analysis module and the learning verification module, compared to the original data and on the basis of statistics information of the non-identified data and information regarding a learning result.

According to another aspect of the present invention, a total periodic de-identification management method of managing de-identification of data, performed by a de-identification management apparatus including a data de-identification processor with a plurality of unit components, includes providing, by a data processing combination unit, information regarding a plurality of unit components to a terminal of an operator from the data de-identification processor so as to non-identify data; selecting, by the data processing combination unit, total periodic work flow parsing information including a combination of unit components for de-identification and evaluation thereof, and transmitting the total periodic work flow parsing information to the data de-identification processor via the terminal of the operator, and non-identifying, by the data de-identification processor, input data by combining the unit components according to the total periodic work flow parsing information transmitted from the data processing combination unit.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a functional block diagram of a total periodic de-identification management apparatus according to an embodiment of the present invention;

FIG. 2 is a functional block diagram of a data processing combination unit according to an embodiment of the present invention;

FIG. 3 is a functional block diagram of a data de-identification processor according to an embodiment of the present invention;

FIGS. 4A and 4B is a functional block diagram of sub-unit components of a data de-identification processor according to another embodiment of the present invention;

FIGS. 5A and 5B is a functional block diagram of a de-identification adequacy evaluator according to an embodiment of the present invention;

FIGS. 6A and 6B is a functional block diagram for describing subunit components of a privacy protection module and a risk analysis module of the de-identification adequacy evaluator according to an embodiment of the present invention;

FIGS. 7A and 7B is a functional block diagram of a data availability evaluator according to another embodiment of the present invention;

FIG. 8 is a functional block diagram for describing subunit components of the data availability evaluator according to another embodiment of the present invention;

FIGS. 9A and 9B is a functional block diagram of a data preprocessor according to another embodiment of the present invention;

FIG. 10 is a reference diagram of a simplest de-identification process which may be performed by a total periodic de-identification management apparatus according to another embodiment of the present invention;

FIGS. 11A and 11B and FIG. 12 are reference diagrams for describing original data and non-identified data according to another embodiment of the present invention;

FIG. 13 is a reference diagram for describing a total periodic data de-identification process according to another embodiment of the present invention;

FIG. 14, FIGS. 15A and 15B are reference diagrams illustrating changes in original data when the original data was actually orchestrated according to total periodic work flow parsing information, according to another embodiment of the present invention; and

FIG. 16 is a flowchart of a total periodic de-identification management method according to an embodiment of the present invention.

FIG. 17 is a block diagram illustrating a computer system to which the present invention is applied.

### DETAILED DESCRIPTION OF EXEMPLARY EMBODIMENTS

Advantages and features of the present invention and methods of achieving them will be apparent from embodiments to be described in detail herein in conjunction with the accompanying drawings. However, the present invention is not limited to the embodiments set forth herein and may be embodied in many different forms. Rather, these embodiments are provided so that this disclosure will be thorough and complete and will fully convey the concept of the invention to those of ordinary skill in the art. The present invention should be defined by the claims appended herein. The terminology used herein is for the purpose of describing embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification, specify the presence of stated components, steps, operations, and/or elements, but do not preclude the presence or addition of one or more other components, steps, operations, and/or elements.

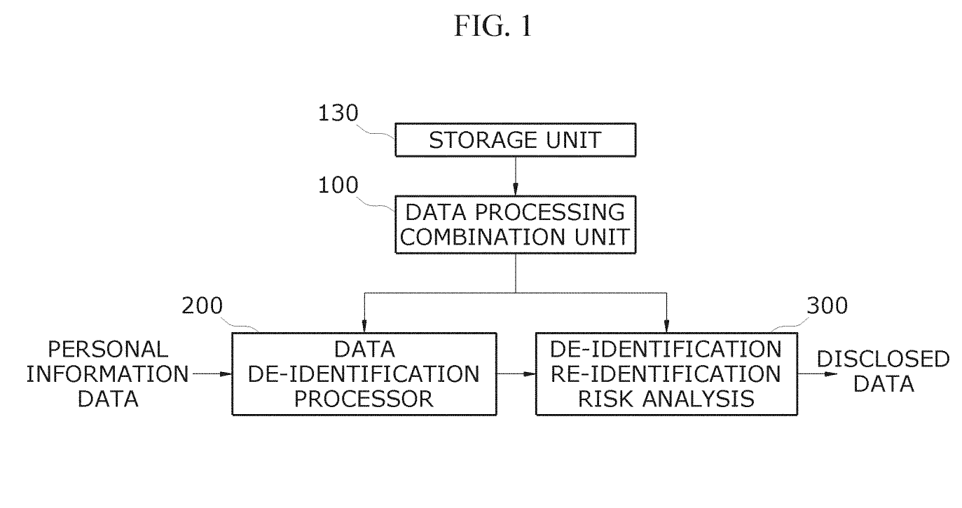

FIG. 1 is a functional block diagram of a total periodic de-identification management apparatus according to an embodiment of the present invention. As illustrated in FIG. 1, the total periodic de-identification management apparatus according to an embodiment of the present invention includes a data processing combination unit 100, a data de-identification processor 200, and a de-identification adequacy evaluator 300.

The data processing combination unit 100 selects total periodic work flow parsing information including a combination of unit components for de-identification and evaluation thereof and transmits this information to the data de-identification processor 200 and the de-identification adequacy evaluator 300, in response to a de-identification request.

The data de-identification processor 200 includes unit components embodied as objects each of which may perform one of sub-functions, and non-identifies input data by combining the unit components according to the total periodic work flow parsing information transmitted from the data processing combination unit 100.

In an embodiment of the present invention, unit components performing data de-identification are selectively combined according to a de-identification request, so that a new de-identification process may be easily created by deleting a specific function from or modifying the specific function in an existing de-identification process or adding a certain function to the existing de-identification process.

In an embodiment of the present invention, the de-identification adequacy evaluator 300 may be further provided.

The de-identification adequacy evaluator 300 includes unit components for evaluating a result of non-identifying data in terms of personal information protection, and evaluates de-identification adequacy of non-identified data by combining the unit components according to the total periodic work flow parsing information transmitted from the data processing combination unit 100.

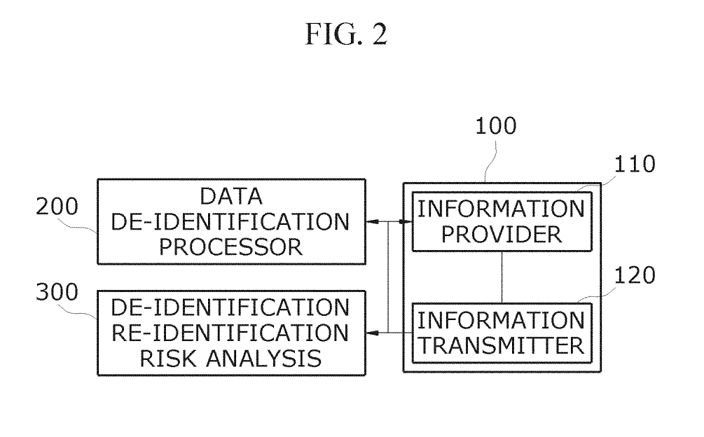

As illustrated in FIG. 2, the data processing combination unit 100 according to an embodiment of the present invention includes an information provider 110 and an information transmitter 120.

The information provider 110 provides work flow information including unit components necessary for de-identification processing and evaluation, so that a flow of a de-identification work of personal information may be selected by an operator. That is, the information provider 110 provides the work flow information including unit components for an operator's convenience through a graphics user interface.

When the operator selects work flow parsing information, the information transmitter 120 transmits the work flow parsing information to the data de-identification processor 200 and the de-identification adequacy evaluator 300.

In an embodiment of the present invention, an operator may selectively combine a unit component performing data de-identification and a unit component performing evaluation of adequacy of the de-identification in response to a de-identification request, and thus, a new de-identification process may be easily created by deleting a specific function from or modifying the specific function in an existing de-identification process or adding a certain function thereto.

According to another embodiment of the present invention, the data processing combination unit 100 may further include a storage unit 130.

In the storage unit 130, the types of input data and a plurality of pieces of work flow parsing information of countries are stored to be mapped to each other. Furthermore, the storage unit 130 may store a library of components of data de-identification processor and a library of components of de-identification adequacy evaluator.

The data processing combination unit 100 checks work flow parsing information from the storage unit 130 according to the de-identification request, and provides the work flow parsing information to the data de-identification processor 200 and the de-identification adequacy evaluator 300 on the basis of this information.

According to the embodiment of the present invention, the work flow parsing information stored in the storage unit 130 is automatically selected according to the de-identification request other than an operator's selection, and thereby de-identification may be optimally performed and a de-identification measures method satisfying a personal information protection standard may be provided according to a de-identification level required and legislation suggested by a country in which data is disclosed.

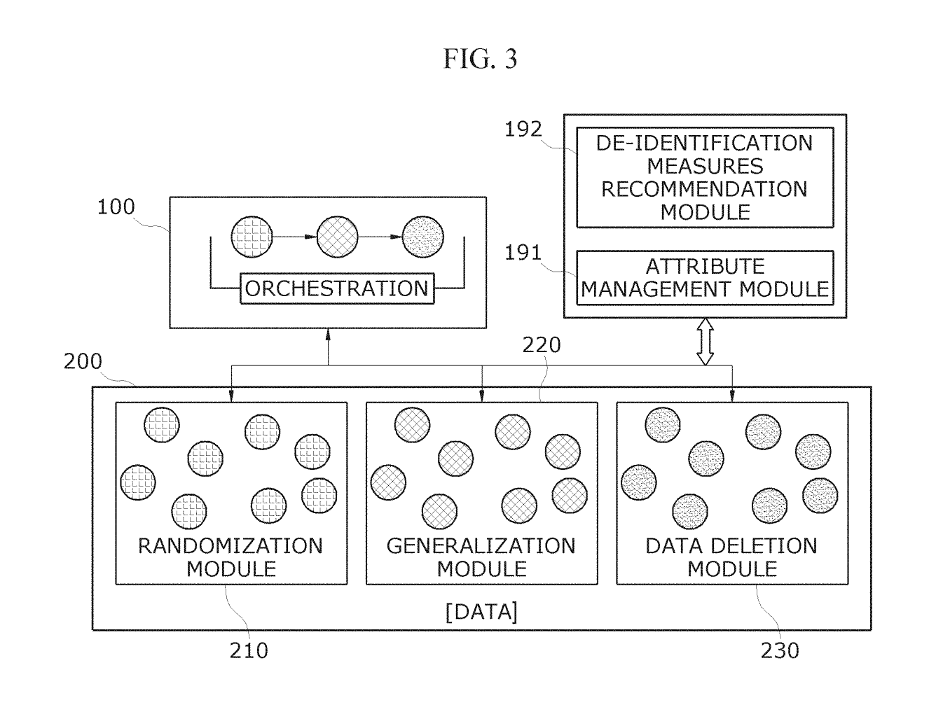

According to an embodiment of the present invention, the data de-identification processor 200 includes a randomization module 210, a generalization module 220, and a data deletion module 230 as illustrated in FIG. 3.

The randomization module 210 includes unit components for changing all or some of randomly selected data values to randomly generated data or adding randomly generated data thereto.

The generalization module 220 includes unit components for generalizing and categorizing a range of data values to prevent identification of a particular individual.

The data deletion module 230 includes unit components for deleting specific data values.

According to another embodiment of the present invention, unit components of the data de-identification processor 200 may be configured based on the ‘Personal Information De-identification Measures Guideline’ issued on Jun. 30, 2016 in South Korea.

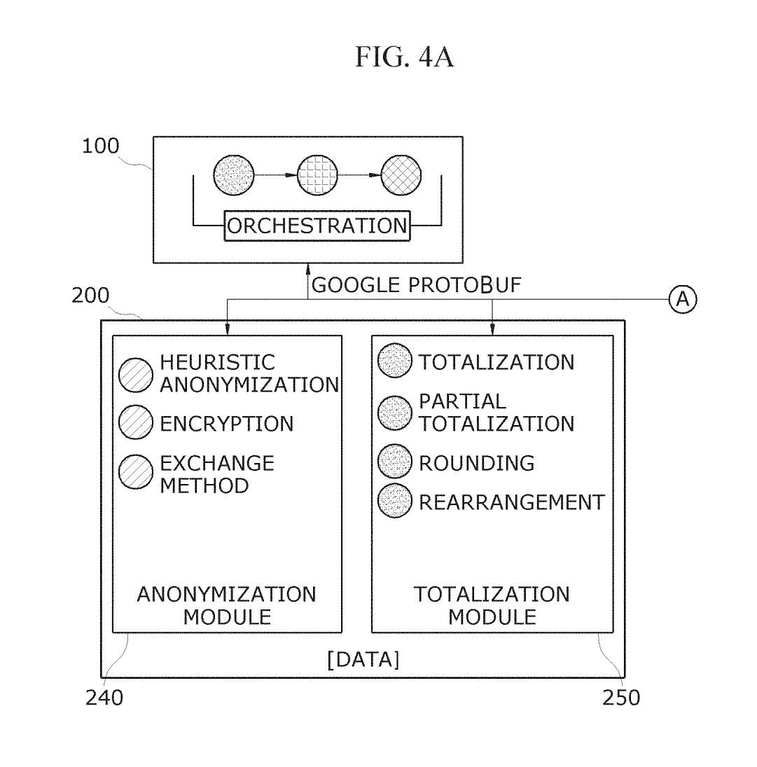

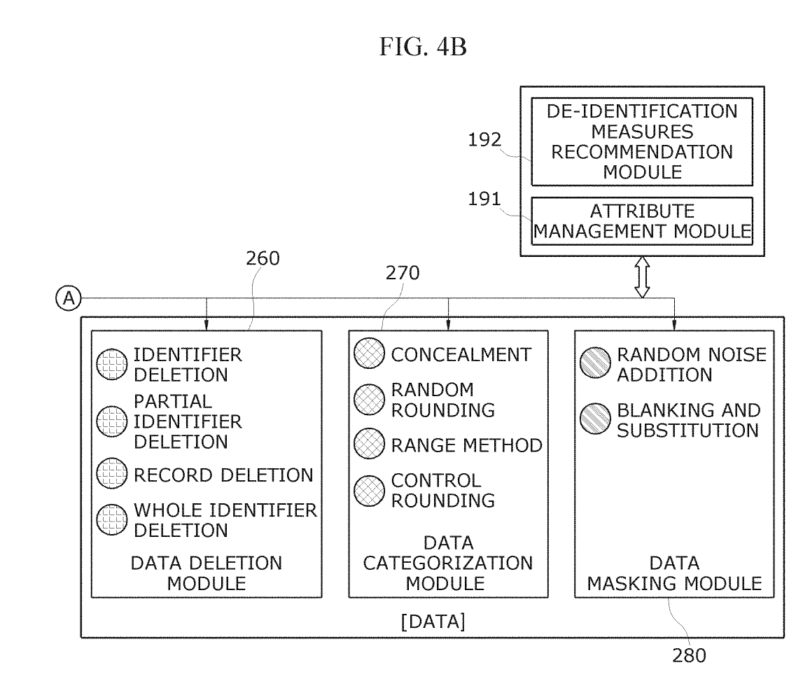

To this end, as illustrated in FIGS. 4A and 4B, according to an embodiment of the present invention, the data de-identification processor 200 may include an anonymization module 240 which includes a unit component for heuristic anonymization, encryption, and an exchange method according to the ‘Personal Information De-identification Action Guideline’, a totalization module 250 which includes a unit component for totalization, partial totalization, rounding, and rearrangement, a data deletion module 260 which includes a unit component for identifier deletion, partial identifier deletion, record deletion, and whole identifier deletion, a data categorization module 270 which includes a unit component for concealment, random rounding, a range method, and control rounding, and a data masking module 280 which includes a unit component for random noise addition, blanking, and substitution.

Here, each of the unit components may be connected in the form of an application programming interface (API) to a controller (not shown) of the data processing combination unit 100 by using a Google protocol buffer (protobuf) or the like.

For example, a data processor may easily perform de-identification on the basis of domestic de-identification guidelines by combining and orchestrating some of the unit components of the data de-identification processor 200 through the data processing combination unit 100. Here, the orchestration of some of the unit components means arranging of an order in which some of the unit components are processed for de-identification.

As illustrated in FIGS. 4A and 4B, the data processing combination unit 100 may perform orchestration to non-identify collected data by applying the unit component of the totalization module 250, applying the unit component of the data deletion module 260, and then applying the unit component of the data categorization module 270.

As described above, the data de-identification processor 200 according to an embodiment of the present invention may remove a unit component that fills a missing value, and an outlying value.

The data de-identification processor 200 according to an embodiment of the present invention further includes an attribute management module 191 and a de-identification measures recommendation module 192.

The attribute management module 191 manages attribute information of collected data in columns, i.e., whether each column corresponds to an identifier or sensitive information.

The de-identification measures recommendation module 192 recommends a de-identification measures method by taking into account an attribute and a feature of each column. For example, the de-identification measures recommendation module 192 may recommend the unit component of the data deletion module 230 for a column corresponding to an identifier such as a resident registration number and a driver's license information, recommend the unit component of the randomization module 210 for a column corresponding to a quasi-identifier such as a name or an address, and recommend to perform de-identification through the unit component of the generalization module 220 or the like in the case of a column corresponding to sensitive information such as age, height, and weight.

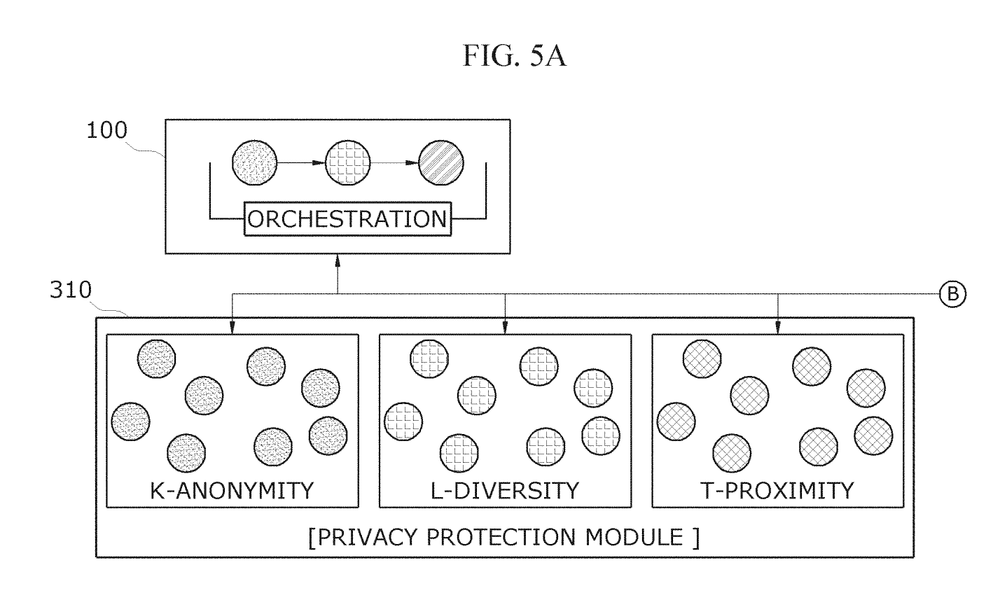

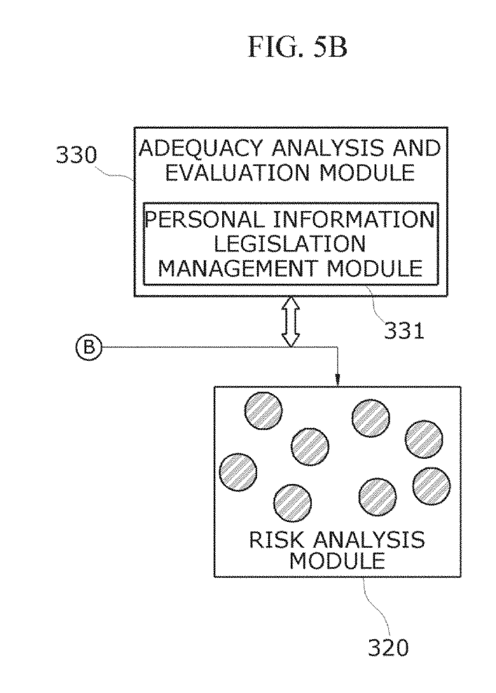

As illustrated in FIGS. 5A and 5B, the de-identification adequacy evaluator 300 according to an embodiment of the present invention includes a privacy protection module 310, a risk analysis module 320, and an adequacy analysis and evaluation module 330.

The privacy protection module 310 includes a unit component, for k-anonymity, which maintains the number of records to be k or more in an equivalence class, which is a set of records of identifiers and attributes which are non-identified with the same values in order to measure a degree of adequacy, to reduce a probability of identifying a specific individual to 1/k or less, a unit component, for 1-diversity, which allocates 1 pieces of different sensitive information in the equivalence class, and a unit component, for t-proximity, which ensures that the difference between a feature distribution of the equivalence class and a feature distribution in all data sets is t or less.

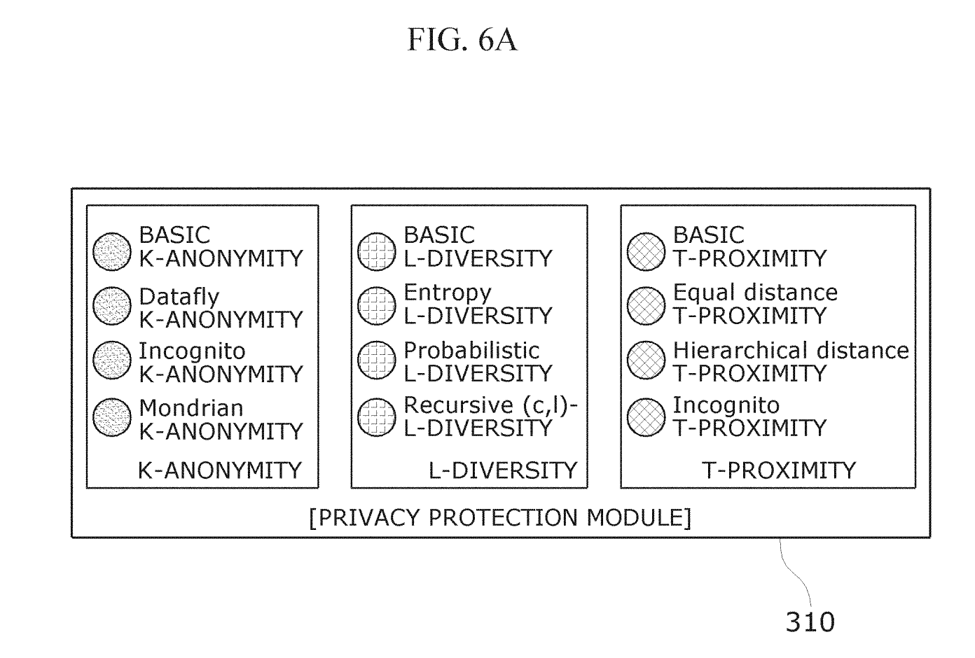

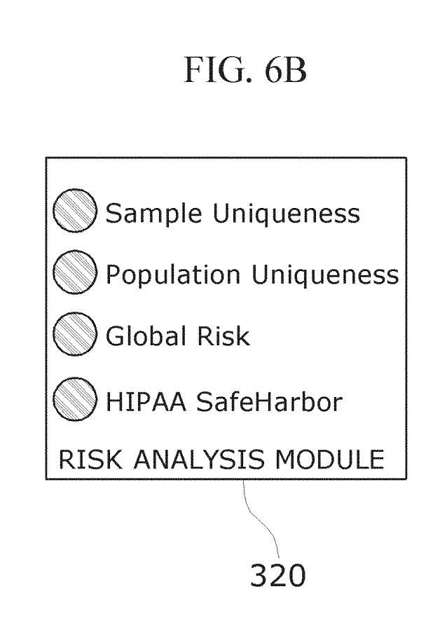

Here, the unit component for k-anonymity, the unit component for 1-diversity, and the unit component for t-proximity include subunit components as illustrated in FIGS. 6A and 6B.

The unit component for k-anonymity includes subunit components such as basic k-anonymity, datafly k-anonymity, incognito k-anonymity, and Mondrian k-anonymity. The unit component for 1-diversity includes subunit components such as basic 1-diversity, entropy 1-diversity, probabilistic 1-diversity, and recursive 1-diversity. The unit component for t-proximity includes subunit components such as basic t-proximity, equal distance t-proximity, hierarchical distance t-proximity, and incognito t-proximity.

The risk analysis module 320 includes a component configured to quantitatively measure a re-identification risk degree of non-identified data. In an embodiment of the present invention, the component of the risk analysis module 320 includes subunit components such as sample uniqueness, population uniqueness, global risk, and HIPAA SafeHarbor to analyze a degree of risk.

The adequacy analysis and evaluation module 330 is configured to finally evaluate adequacy on the basis of a degree of adequacy measured and calculated and a re-identification risk value, and the above-described legislation, and evaluates whether non-identified data is adequate through the privacy protection module 310 and the risk analysis module 320.

Here, information regarding the measured and calculated adequacy may be used differently depending on a level of personal information protection. For example, a protection level of data including information uniquely identifying an individual, such as a residence registration number, may be set to be very high, whereas a protection level of data including information indirectly identifying an individual, such as name or age may be set to be middle.

For example, an evaluation of adequacy may be performed simply with a k-value calculated using the unit component for k-anonymity when a protection level of personal information may be low, and may be performed with not only the k-value but also an 1-value calculated using the unit component for the 1-diversity and a t-value calculated using the unit component for t-proximity when the protection level is high.

Accordingly, in an embodiment of the present invention, a de-identification measure level for personal information protection may be determined on the basis of contents of a personal information legislation management module included in the adequacy analysis and evaluation module 330, a k-value of non-identified data may be calculated and compared using a k-anonymity value in a privacy protection model, and a re-identification risk degree may be analyzed.

In an embodiment of the present invention, the adequacy analysis and evaluation module 330 of the de-identification adequacy evaluator 300 includes a personal information legislation management module 331.

The personal information legislation management module 331 manages personal information protection-related legislation of each country. Here, the personal information legislation management module 331 may manage legislation related to the protection of personal information in each country, e.g., the EU General Data Protection Regulation (GDPR) covering guidelines for the protection of personal information coming into effect as from May 2018, the USA Health Insurance Portability and Accountability Act (HIPAA) for health insurance transfer and responsibility, and the Japan Personal Information Protection Act introduced to promote the rational utilization of personal information, but the personal information legislation of each country is not limited thereby.

According to an embodiment of the present invention, it is easy to implement not only an re-identification risk analysis method required by the domestic guidelines but also an re-identification risk analysis method required by each country's guidelines.

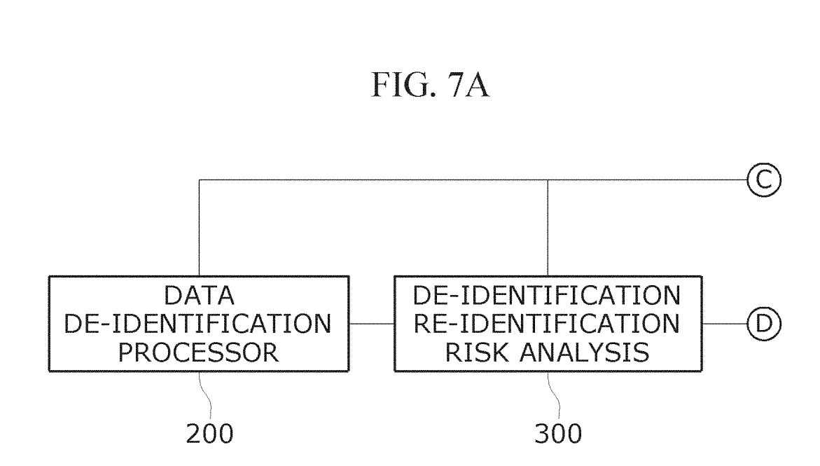

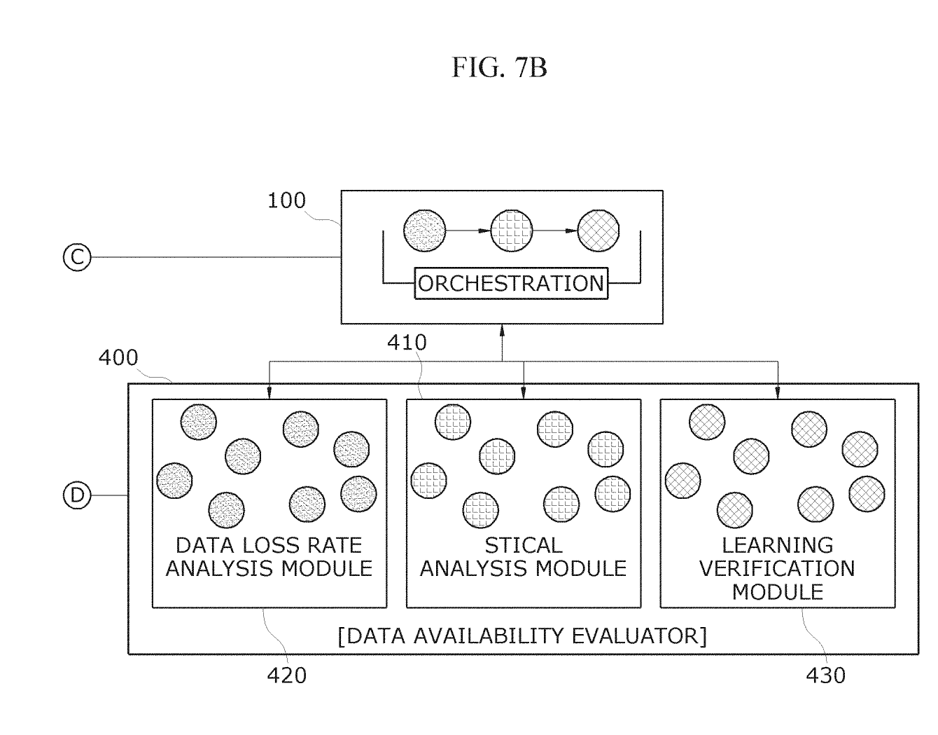

In another embodiment of the present invention, the data processing combination unit 100, the data de-identification processor 200, and the de-identification adequacy evaluator 300 according to the previous embodiment are provided, and a data availability evaluator 400 is further provided as illustrated in FIGS. 7A and 7B.

The data availability evaluator 400 includes unit components embodied as objects each of which may perform one of sub-functions, and is configured to evaluate a degree of availability of non-identified data passing the re-identification risk analysis by combining the unit components according to the total periodic work flow parsing information transmitted from the data processing combination unit 100.

Unlike in the previous embodiment, the data processing combination unit 100 selects total periodic work flow parsing information including a combination of unit components for de-identification and evaluation thereof among the unit components of the data de-identification processor 200, the de-identification adequacy evaluator 300, and the data availability evaluator 400, in response to a de-identification request, and provides this information to the data de-identification processor 200, the de-identification adequacy evaluator 300, and the data availability evaluator 400.

In another embodiment of the present invention, the data availability evaluator 400 includes a statistical analysis module 410, a data loss rate analysis module 420, and a learning verification module 430 as illustrated in FIGS. 7A and 7B.

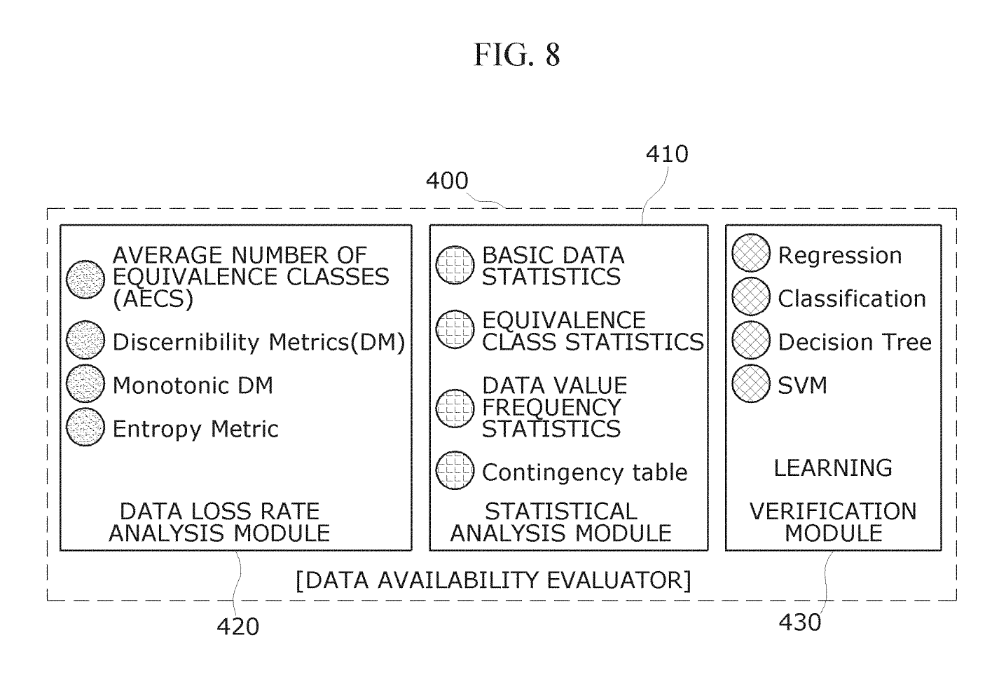

The statistical analysis module 410 is used to analyze statistical characteristics of data, and includes a unit component for obtaining basic data statistics, a unit component for a correlation analysis for each column, and a unit component for obtaining statistical information related to an equivalence class derived through de-identification processing. In the present embodiment, the statistical analysis module 410 has a unit component for performing basic data statistics, equivalence class statistics, data value frequency statistics, and contingency table functions as illustrated in FIG. 8.

The data loss rate analysis module 420 handles a net loss rate of data itself other than information contained in the data, and includes a unit component for analyzing and comparing a loss rate of non-identified data with respect to original data, a unit component for analyzing the loss rate in units of columns by expanding a loss rate in units of cells to a loss rate in units of columns, and a unit component for expanding and analyzing the loss rate in a whole data unit. In the present embodiment, the data loss rate analysis module 420 includes a unit component for basis data statistics, a unit component for equivalence class statistics, a unit component for data value frequency statistics, and a unit component for a contingency table as illustrated in FIG. 8.

The learning verification module 430 includes a unit component of a learning model, such as a decision tree and regression, to analyze and compare a non-identified data-based learning result versus an original data-based learning result, and analyze a loss rate in terms of data utilization for statistical and academic purposes which are data disclosure purposes. In an embodiment of the present invention, the learning verification module 430 includes unit components of various types of learning models, such as regression, classification, a decision tree, and a support vector machine (SVM), to analyze and compare a non-identified data-based learning result versus an original data-based learning result by using the above-described learning methods as illustrated in FIG. 8.

Thus, according to another embodiment of the present invention, a data processor is capable of deriving information regarding a non-identified data-based learning result, as well as simple statistical academic information, by using various unit components provided by the data availability evaluator 400 of such a platform. Accordingly, a value of utilization of the non-identified data may be verified before this data is disclosed.

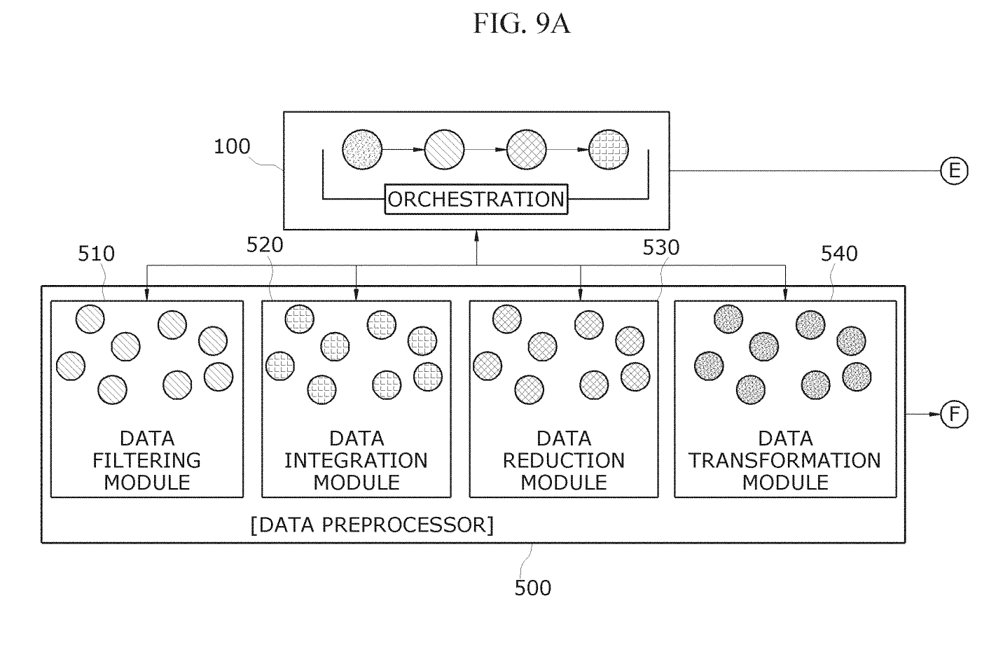

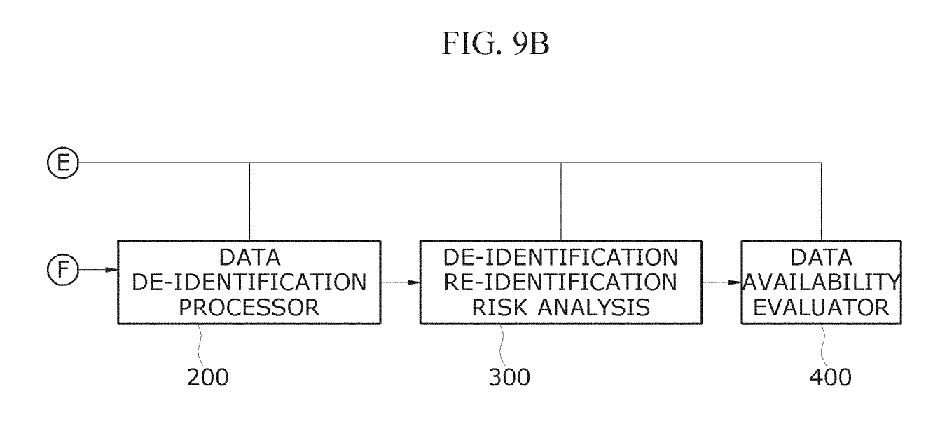

In another embodiment of the present invention, the data processing combination unit 100, the data de-identification processor 200, and the de-identification adequacy evaluator 300 according to the previous embodiment are provided, and a data preprocessor 500 illustrated in FIGS. 9A and 9B is further provided.

The data preprocessor 500 is operated before the data de-identification processor 200, includes unit components embodied as objects each of which may perform one of sub-functions, and preprocesses input data by combining the unit components according to the total periodic work flow parsing information transmitted from the data processing combination unit 100.

Unlike in the previous embodiment, the data processing combination unit 100 selects total periodic work flow parsing information including a combination of unit components for de-identification and evaluation thereof among the unit components of the data de-identification processor 200, the de-identification adequacy evaluator 300, the data availability evaluator 400, and the data preprocessor 500, in response to a de-identification request, and provides the total periodic work flow parsing information to the data de-identification processor 200, the de-identification adequacy evaluator 300, the data availability evaluator 400, and the data preprocessor 500.

In another embodiment of the present invention, the data preprocessor 500 includes a data filtering module 510, a data integration module 520, a data reduction module 530, and a data transformation module 540.

The data filtering module 510 includes unit components for fixing data inconsistency by filling a missing value, alleviating a noise value, or finding and removing an outlier.

The data integration module 520 includes unit components for selecting only desired data from among a plurality of data sets and integrating and merging the desired data into one data set.

The data reduction module 530 provides unit components for reducing the size of data while keeping analysis results the same.

The data transformation module 540 includes unit components for arbitrarily transforming data while maintaining characteristics of the data to maximize the efficiency of a data mining algorithm.

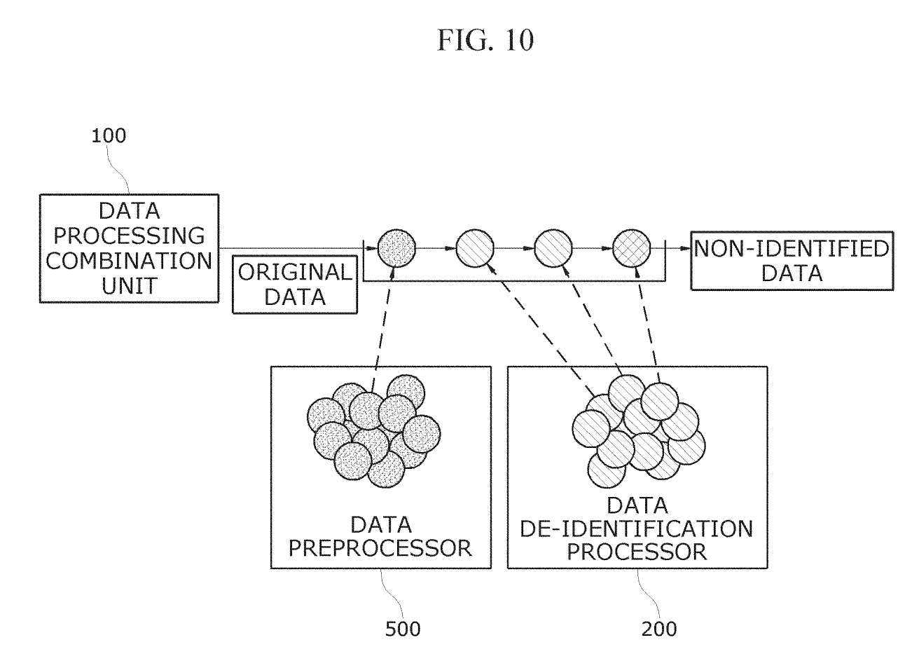

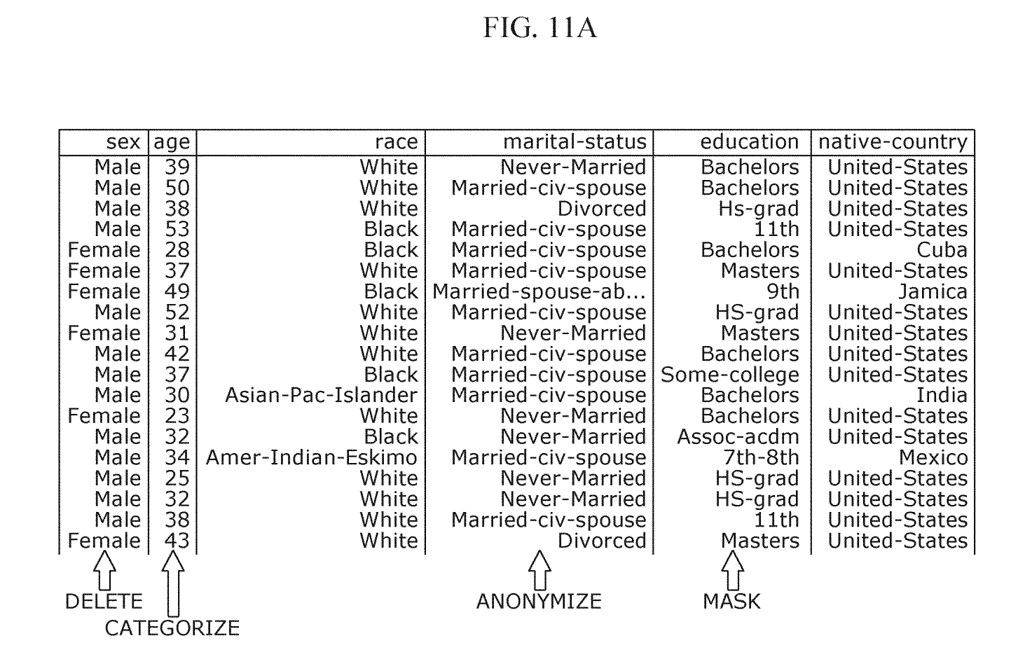

A process of operating a total periodic de-identification management apparatus according to another embodiment of the present invention will be described with reference to FIG. 10 below.

FIG. 10 illustrates a simplest de-identification processing example which may be performed by a total periodic de-identification management apparatus according to another embodiment of the present invention, in which collected data is non-identified on the basis of the de-identification action guidelines jointly published by government departments in June of 2016.

A data processor may create total periodic work flow parsing information with the data processing combination unit 100, in which the unit component having an identifier deletion function of the data preprocessor 500 is applied, and thereafter, the unit component having a categorization function, the unit component having an anonymization function, and the unit component having a masking function of the data de-identification processor 200, may be sequentially performed.

Thus, the data processing combination unit 100 parses the unit components of the data preprocessor 500 and the data de-identification processor 200, deletes an identifier of data by calling the unit component having the identifier deletion function of the data preprocessor 500 according to a procedure, and actually non-identifies a quasi-identifier by using the unit component having the categorization function, the unit component having the anonymization function, and the unit component having the masking function of the data de-identification processor 200, based on the total periodic work flow parsing information.

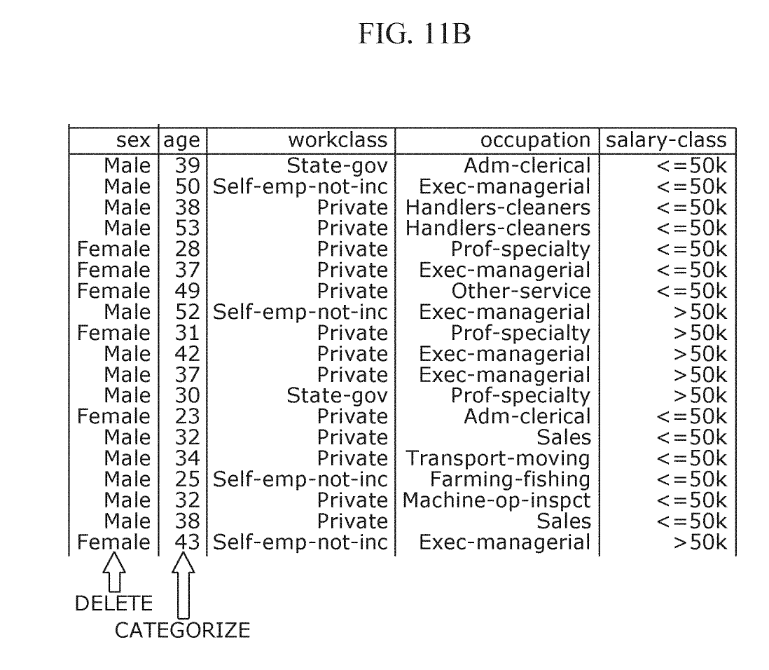

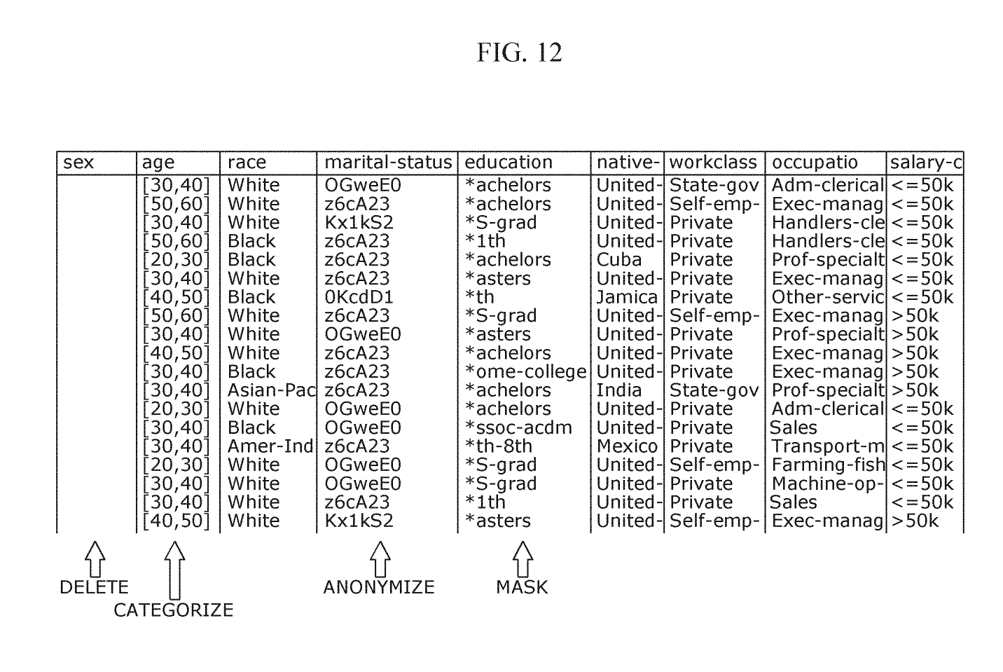

To help understood another embodiment of the present invention, changes in original data when the original data is actually orchestrated according to the total periodic work flow parsing information will be described with reference to FIGS. 11A and 11B and FIG. 12 below.

First, it is assumed as illustrated in FIGS. 11A and 11B that original data is U.S. electoral register data.

According to another embodiment of the present invention, a total periodic de-identification management apparatus applies the unit component having the identifier deletion function to a sex column which is a first column of the original data, the unit component having the categorization function to an age column, the unit component having the anonymization function to a marital-status column, and the unit component having the masking function to an education column, based on total periodic work flow parsing information set by a data processor.

FIG. 12 is a reference diagram illustrating changes in data after unit components are applied to the data according to total periodic work flow parsing information, performed by a total periodic de-identification management apparatus according to another embodiment of the present invention.

As illustrated in FIG. 12, the sex column to which the unit component having the identifier deletion function was applied disappeared due to the application of the identifier deletion function, and age information was categorized in numbers of ten, e.g., [30, 40], in the age column to which the unit component having the categorization function was applied. A value of the marital-status column to which the unit compound having the anonymization function was applied was replaced with random character strings which are a combination of numbers and uppercase and lowercase letters. A first character in each row of the education column to which the unit component having the masking function was applied was masked with an asterisk (*).

Accordingly, according to another embodiment of the present invention, unit components may be combined according to an operator's choice and collected data may be easily non-identified using the combination of the unit components on the basis of the de-identification action guidelines published in Korea.

A total periodic de-identification process performed by a total periodic de-identification management apparatus according to another embodiment of the present invention to protect personal information and increase data availability will be described below.

The total periodic de-identification management apparatus according to another embodiment of the present invention may perform de-identification process in which the data preprocessor 500, the data de-identification processor 200, the de-identification adequacy evaluator 300, and the data availability evaluator 400 are totally periodically operated and managed.

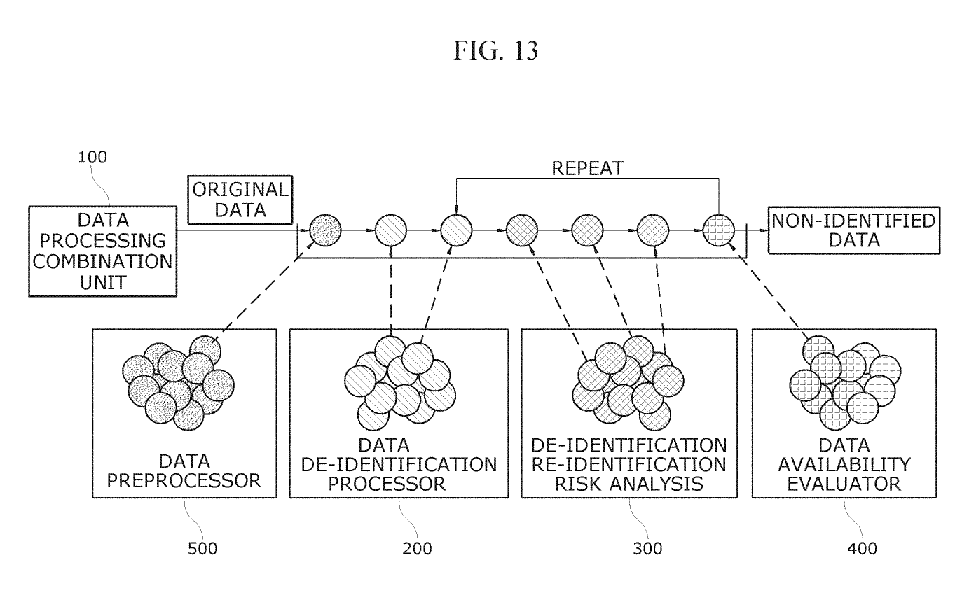

FIG. 13 illustrates a total periodic data de-identification process according to another embodiment of the present invention.

As illustrated in FIG. 13, a data processor may create, by using the data processing combination unit 100, total periodic work flow parsing information consisting of processes of performing basic data filtering, e.g., filling a missing value, non-identifying data through an identifier deletion function and a quasi-identifier generalization function, applying k-anonymity, checking whether a k-value is appropriate, checking a re-identification risk degree and a global risk degree, and checking a cardinality loss rate of the non-identified data according the procedure, and may set a k-value, which is a reference adequacy value of k-anonymity for protection of personal information, to be 4 or more.

Thus, in a total periodic de-identification management apparatus according to another embodiment of the present invention, data is orchestrated as specified in total periodic work flow parsing information by combining a unit component having a missing value population function of a data preprocessor 500, a unit component having an identifier deletion function and a unit component having a quasi-identifier generalization function of a data de-identification processor 200, a unit component having k-anonymity re-identification risk analysis function, a unit component having an individual re-identification risk measurement function, and a unit component having a global risk measurement function of a de-identification adequacy evaluator 300, and a unit component having a cardinality loss rate measurement function of a data availability evaluator 400.

In particular, in another embodiment of the present invention, a criterion for adequacy of protection of personal information is given and thus a process of generalizing a quasi-identifier and a process of measuring a loss rate may be repeatedly performed until the criterion is satisfied.

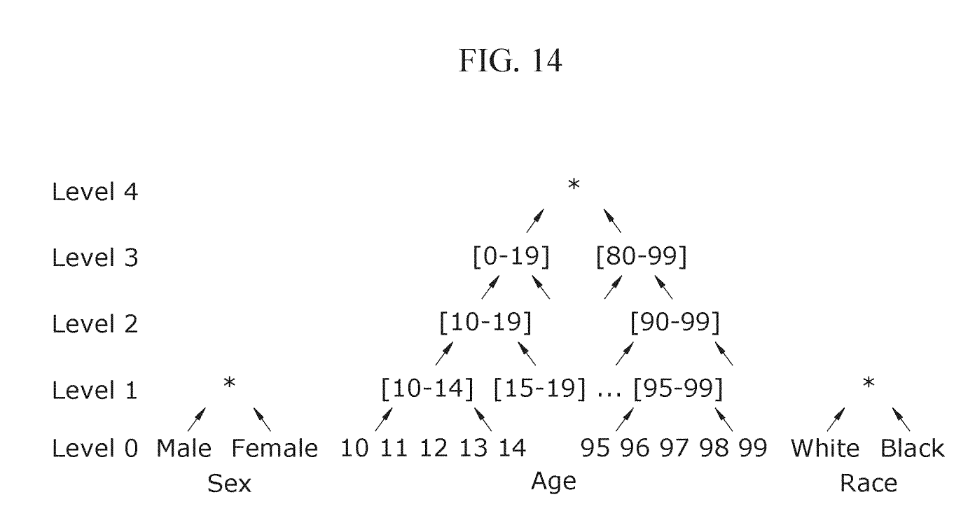

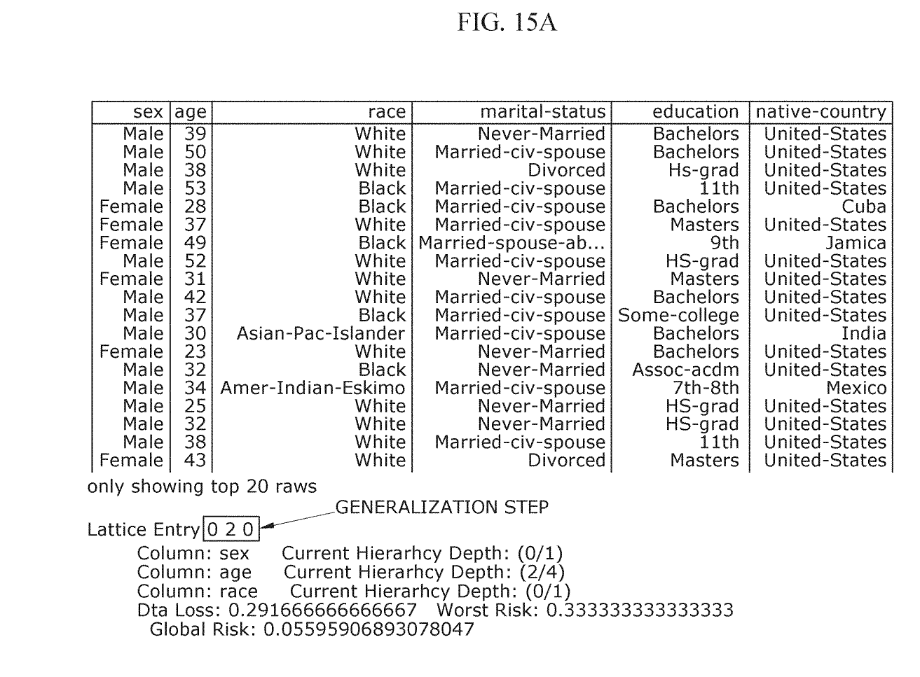

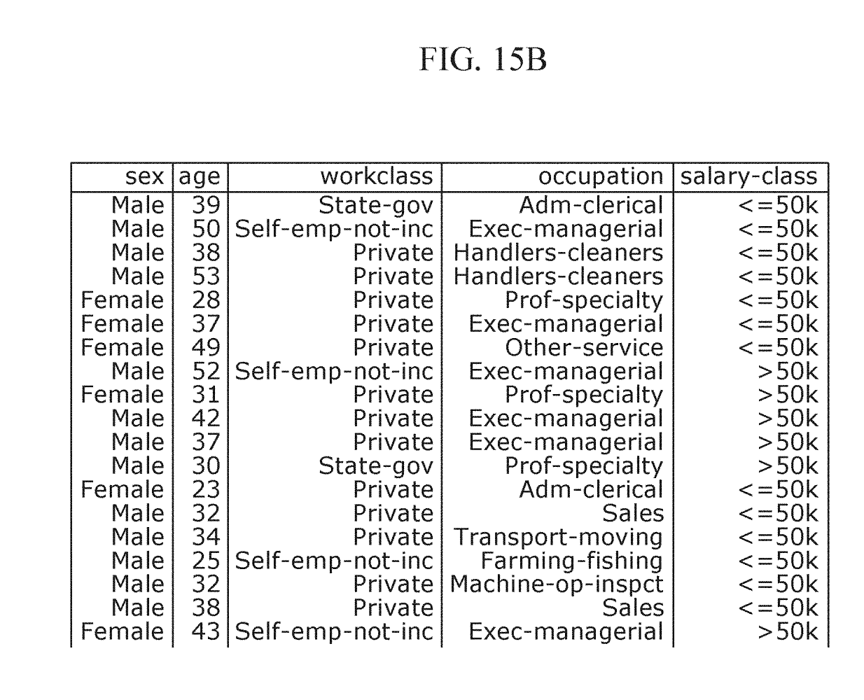

To help understanding of the present embodiment of the present invention, when original data is actually orchestrated according to the total periodic work flow parsing information, changes in the original data will be described with reference to FIG. 14, FIGS. 15A and 15B below.

To this end, it is assumed that the original data is a piece of U.S. electoral register data, quasi-identifiers of the original data are categorized in a sex column, an age column, and a race column, and changes in quasi-identifier data when the quasi-identifiers are generalized are as shown in FIG. 14.

Thus, in another embodiment of the present invention, the generalization of the quasi-identifiers is defined as [0, 2, 1], i.e., values of the quasi-identifier in the sex column which is a first column are generalized as Level 0, values of the quasi-identifier in the age column which is a second column are generalized as Level, and values of the quasi-identifier in the race column which is a third column are generalized as Level 0.

For example, when [Male, 39, White] which is information in a first row of FIGS. 15A and 15B is generalized by applying [0, 2, 1] thereto, [0, 2, 1] is changed to [*, 30-40, *].

Thus, in a total periodic de-identification management apparatus according to another embodiment of the present invention, generalization of [0, 0, 0] is applied to original data to non-identify the original data, and a k-value, a re-identification risk degree, and a global risk degree of the non-identified data are verified.

When it is verified that the k-value of the non-identified data is less than a k-value specified in total periodic work flow parsing information (i.e., when an re-identification risk analysis is not satisfied), the data is non-identified again by a data de-identification processor 200.

In this case, a level of generalization is increased by 1 to increase [0, 0, 0] to [0, 1, 0] or the like, and [0, 1, 0] is applied to the original data. Thus, ages are categorized into five-year intervals, and the re-identification risk analysis is performed again.

FIGS. 15A and 15B illustrates information such as a data loss rate, a re-identification risk degree, a global risk degree, etc. when generalization of [0, 2, 0] was applied during the repetition of the process.

A degree of adequacy may be evaluated on the basis of such information, and data which is non-identified through the generalization may be disclosed when a result of evaluating the degree of adequacy is satisfactory.

When the result of evaluating the degree of adequacy is satisfactory, the data may be directly disclosed or data which is non-identified by a generalization step of a lowest loss rate among generalization steps satisfying the evaluation of a degree of adequacy after all generalization steps are performed may be disclosed.

In this case, data satisfying a criterion of adequacy for protection of personal information required by a data processor and having a lowest data loss rate may be disclosed.

In another embodiment of the present invention, the data processor is capable of easily performing a data de-identification process in other various ways to protect personal information and increase data utilization.

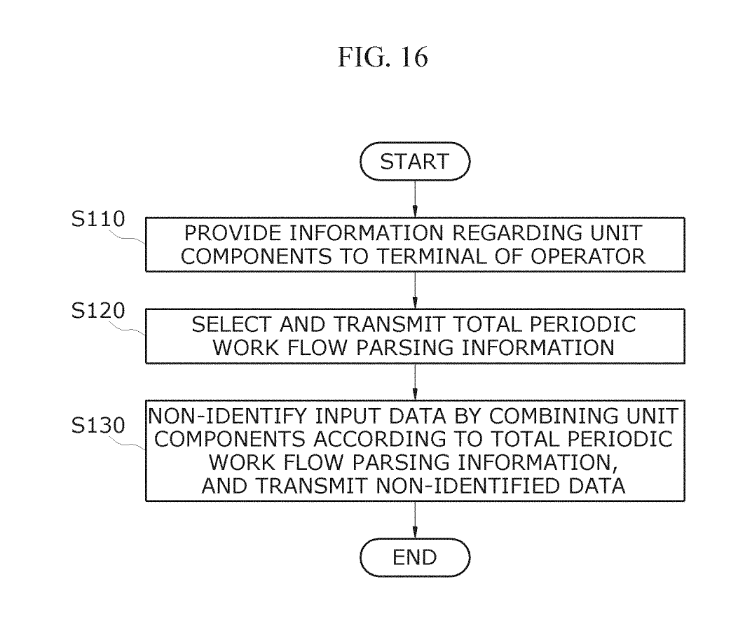

FIG. 16 is a flowchart of a total periodic de-identification management method according to an embodiment of the present invention.

A total periodic de-identification management method according to an embodiment of the present invention will be described with reference to FIG. 16 below.

In an embodiment of the present invention, first, the total periodic de-identification management method may be performed by subcomponents of a de-identification management apparatus.

A data processing combination unit provides information regarding a plurality of unit components from a data de-identification processor to a terminal of an operator so as to non-identify data (S110).

Next, the data processing combination unit selects total periodic work flow parsing information including a combination of unit components for de-identification processing and evaluation, and transmits this information to the data de-identification processor via the terminal of the operator (S120).

Thereafter, the data de-identification processor non-identifies input data by combining the unit components according to the total periodic work flow parsing information transmitted from the data processing combination unit (S130).

In an embodiment of the present invention, unit components are selectively combined to non-identify data, in response to a de-identification request, and thus, a new de-identification process may be easily created by deleting a specific function from or modifying a specific function in an existing de-identification process or adding a function thereto.

According to an embodiment of the present invention, work flow parsing information stored in a storage unit may be automatically selected, in response to a de-identification request other than an operator's selection, and thereby de-identification may be optimally performed. Furthermore, de-identification measures method may be provided to satisfy a standard for protection of personal information according to a level of de-identification required and legislation suggested by a country in which information is disclosed.

In an embodiment of the present invention, a level of de-identification measures for protection of personal information is determined on the basis of contents of a personal information legislation management module included in an adequacy analysis and evaluation module, and a k-value of non-identified data is calculated and compared and a re-identification risk degree may be analyzed using a k-anonymity value of a privacy protection model.

In an embodiment of the present invention, not only a method of evaluating adequacy required in domestic guidelines but also a method of evaluating adequacy required in guidelines of each country may be easily embodied.

In another embodiment of the present invention, a data processor may derive not only simple statistical academic information but also information regarding non-identified data-based learning result by using various unit components of a data availability evaluator of such a platform, and thus, a value of utilization of non-identified data before the data is disclosed may be verified.

In another embodiment of the present invention, the data processor may easily create a data de-identification process in other various ways to protect personal information and increase data utilization.

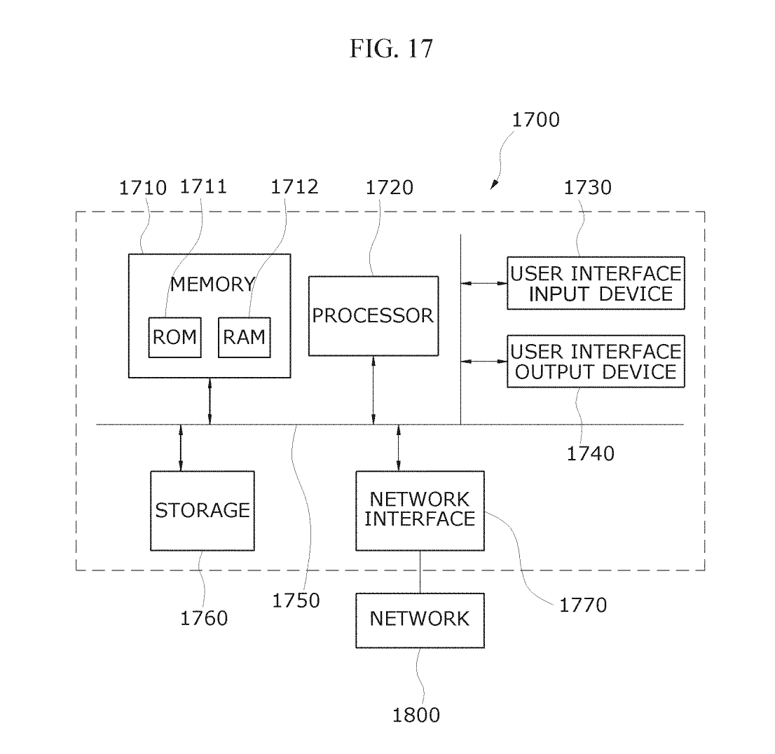

FIG. 17 is a block diagram illustrating a computer system to which the present invention is applied.

As shown in FIG. 17, a computer system 1700 may include one or more of a memory 1710, a processor 1720, a user input device 1730, a user output device 1740, and a storage 1760, each of which communicates through a bus 1750. The computer system 1700 may also include a network interface 1770 that is coupled to a network 1800. The processor 1720 may be a central processing unit (CPU) or a semiconductor device that executes processing instruction stored in the memory 1710 and/or the storage 1760. The memory 1710 and the storage 1760 may include various forms of volatile or non-volatile storage media. For example, the memory 1710 may include a read-only memory (ROM) 1711 and a random access memory (RAM) 1712.

Accordingly, an embodiment of the invention may be implemented as a computer implemented method or as a non-transitory computer readable medium with computer executable instruction stored thereon. In an embodiment, when executed by the processor, the computer readable instruction may perform a method according to at least one aspect of the invention.

While the structures of the present invention have been described in detail with reference to the accompanying drawings, they are merely examples and it will be apparent to those skilled in the art that various modifications and changes may be made therein without departing from the spirit or scope of the invention. Accordingly, the scope of the present invention should not be limited by the above-described embodiments and should be determined by the appended claims.

What is claimed is:

1. A total periodic de-identification management apparatus comprising:
a data processing combination unit configured to transmit total periodic work flow parsing information including a combination of unit components for de-identification and evaluation thereof, in response to a de-identification request;
a data de-identification processor including unit components embodied as single-operation objects, and configured to non-identify input data by combining the unit components according to the total periodic work flow parsing information; and
a de-identification adequacy evaluator including unit components for evaluating the de-identification of the data in terms of protection of personal information, and configured to evaluate a degree of adequacy of de-identification of the non-identified data by combining the unit components according to the total periodic work flow parsing information.

2. The apparatus of claim 1, wherein the data processing combination unit comprises:
an information provider configured to provide work flow information including a unit component for de-identification and evaluation thereof so as to allow an operator to select a de-identification work flow of personal information; and
an information transmitter configured to transmit the total periodic work flow parsing information including the combination of the unit components according to the operator's selection.

3. The apparatus of claim 1, further comprising a storage unit configured to store work flow parsing information according to a type of input data and a country,
wherein the data processing combination unit checks the work flow parsing information stored in the storage unit according to the de-identification request, and provides work flow parsing information on the basis of the work flow parsing information.

4. The apparatus of claim 1, wherein the data de-identification processor comprises:
a unit component configured to fill a missing value; and
a unit component configured to remove an outlier.

5. The apparatus of claim 1, wherein the data de-identification processor further comprises:
an attribute management module configured to manage attribute information of collected data in units of columns, the management of the attribute information including managing whether each of the columns corresponds to an identifier or sensitive information; and
a de-identification measures recommendation module configured to recommend a de-identification measures method by taking into account an attribute and a feature of each of the columns.

6. The apparatus of claim 1, wherein the data de-identification processor comprises:
a randomization module including unit components configured to change all or some of randomly selected data values to randomly generated data or add the randomly generated data;
a generalization module including unit components configured to generalize and categorize a range of data values to prevent a specific individual from being identified; and
a data deletion module including unit components configured to delete a specific data value.

7. The apparatus of claim 1, wherein the de-identification adequacy evaluator comprises a privacy protection module,
wherein the privacy protection module comprises:
a k-anonymity component configured to reduce a probability of identifying a specific individual to 1/k or less so as to measure a degree of adequacy by maintaining a number of records to be k or more in an equivalence class, which is a set of records of identifiers and attributes which are non-identified with the same values;
an 1-diversity component configured to allow presence of 1 pieces of different sensitive information in the equivalence class; and
a t-proximity component configured to ensure that a difference between a feature distribution in the equivalence class and a feature distribution in all data sets is t or less.

8. The apparatus of claim 7, wherein the de-identification adequacy evaluator comprises an adequacy analysis and evaluation module configured to finally evaluate adequacy on the basis of a degree of adequacy measured and calculated, a re-identification risk degree, and legislation of a country, the evaluation of the adequacy being performed using the privacy protection module and a risk analysis module.

9. The apparatus of claim 8, wherein the de-identification adequacy evaluator comprises a personal information legislation management module configured to manage legislation related to protection of personal information of each country.

10. The apparatus of claim 1, wherein the de-identification adequacy evaluator comprises a risk analysis module including a component configured to quantitatively measure a re-identification risk degree of the non-identified data.

11. The apparatus of claim 10, wherein the de-identification adequacy evaluator uses at least one among a sample uniqueness model, a population uniqueness model, a global risk model, and a HIPAA SafeHarbor model to analyze a risk degree.

12. The apparatus of claim 1, further comprising a data availability evaluator including unit components embodied as single-operation objects, and configured to evaluate a degree of availability of the non-identified data passing the evaluation of the degree of adequacy by combining the unit components according to the total periodic work flow parsing information transmitted from the data processing combination unit.

13. The apparatus of claim 12, wherein the data availability evaluator comprises:
a statistical analysis module configured to analyze statistical feature of data, the statistical analysis module including a unit component for obtaining basic data statistics, a unit component for a correlation analysis for each column, and a unit component for obtaining statistical information related to an equivalence class derived through de-identification processing;
a data loss rate analysis module configured to handle a net loss rate of data itself other than information contained in the data, the data loss rate analysis module including a unit component for analyzing and comparing a loss rate of the non-identified data with respect to original data, a unit component for analyzing a loss rate in units of columns by expanding a loss rate in units of cells to a loss rate in units of columns, and a unit component for expanding and analyzing the loss rate in a whole data unit; and
a learning verification module including a unit component of a leaning model to compare and analyze a result of learning based on the non-identified data versus a result of learning based on the original data, and analyze a loss rate in terms of statistical and academic purposes which are purposes of data disclosure, wherein examples of the learning model include a decision tree and regression.

14. The apparatus of claim 13, wherein the learning verification module comprises unit components of various learning models to compare and analyze the result of learning based on the non-identified data versus the result of learning based on the original data, wherein examples of the various learning models include regression, classification, a decision tree, and a support vector machine (SVM).

15. The apparatus of claim 1, further comprising a data availability evaluator configured to measure a degree of availability of the non-identified data in various ways.

16. The apparatus of claim 15, wherein the data availability evaluator comprises:
a statistical analysis module including a unit component for calculating basic data statistics, equivalence class statistics, and data value frequency statistics, and performing contingency table functions; and
a data loss rate analysis module configured to analyze and compare a loss rate of the non-identified data with respect to original data.

17. The apparatus of claim 16, wherein the data availability evaluator comprises:
a unit component configured to evaluate a degree of data availability only on the basis of a data loss rate; and
a unit component configured to evaluate a degree of data availability using the statistical analysis module and a learning verification module, compared to the original data and on the basis of statistics information of the non-identified data and information regarding a learning result.

18. The apparatus of claim 1, further comprising a data preprocessor including unit components embodied as objects each of which performs one of sub-functions, and configured to preprocess input data by combining the unit components according to the total periodic work flow parsing information transmitted from the data processing combination unit.

19. The apparatus of claim 18, wherein the data preprocessor comprises:
a data filtering module including unit components configured to fix data inconsistency by filling a missing value or alleviating a noise value, and finding and removing an outlier,
a data integration module including unit components configured to select only desired data from among a plurality of data sets and integrate and merge the selected data into one data set;
a data reduction module including unit components configured to reduce data size while keeping analysis results the same; and
a data transformation module including unit components configured to arbitrarily transform data while maintaining features of the data to maximize efficiency of a data mining algorithm.

20. A total periodic de-identification management method of managing de-identification of data, performed by a de-identification management apparatus including a data de-identification processor with a plurality of unit components, the method comprising:
providing, by a data processing combination unit, information regarding a plurality of unit components to a terminal of an operator from the data de-identification processor so as to non-identify data;
selecting, by the data processing combination unit, total periodic work flow parsing information including a combination of unit components for de-identification and evaluation thereof, and transmitting the total periodic work flow parsing information to the data de-identification processor via the terminal of the operator; and
non-identifying, by the data de-identification processor, input data by combining the unit components according to the total periodic work flow parsing information transmitted from the data processing combination unit.
